(19) United States
(12) Patent Application Publication
(10) Pub. No.: US 2019/0392129 A1
(43) Pub. Date: Dec. 26, 2019

(54) IDENTITY AUTHENTICATION METHOD

(71) Applicant: ELAN MICROELECTRONICS CORPORATION, Hsinchu (TW)

(72) Inventors: Cheng-Shin Tsai, Taoyuan City (TW); Fang-Yu Chao, Taipei City (TW); Chih-Yuan Cheng, Taichung City (TW); Wei-Han Lin, Hsinchu (TW)

(73) Assignee: ELAN MICROELECTRONICS CORPORATION, Hsinchu (TW)

(21) Appl. No.: 16/265,628

(22) Filed: Feb. 1, 2019

Related U.S. Application Data
(60) Provisional application No. 62/690,311, filed on Jun. 26, 2018.

(30) Foreign Application Priority Data
Oct. 2, 2018 (TW) 107134823

(51) Int. Cl. G06F 21/32; G06K 9/00; G06K 9/03

(52) U.S. Cl. CPC G06F 21/32; G06K 9/00892; G06K 9/00617; G06K 9/00087; G06K 9/036; G06K 9/00288

(57) ABSTRACT

An identity authentication method verifies an identity by selecting a portion of the first biometric information and all or part of a second biometric information. The identity authentication method uses part of the biometric information of the user to perform authentication, which may improve the convenience of use. The identity authentication method adopts two biometric verifications, which may maintain the accuracy of the authentication.

### CROSS-REFERENCE TO RELATED APPLICATIONS

This application claims the benefit of United States provisional application filed on Jun. 26, 2018 and having application Ser. No. 62/690,311, the entire contents of which are hereby incorporated herein by reference

This application is based upon and claims priority under 35 U.S.C. 119 from Taiwan Patent Application No. 107134823 filed on Oct. 2, 2018, which is hereby specifically incorporated herein by this reference thereto.

### BACKGROUND OF THE INVENTION

### 1. Field of the Invention

The present invention relates to an identity authentication method, especially to a method for verifying identity according to two different types of biometric information.

### 2. Description of the Prior Arts

In recent days, many electronic devices use human biometric features for identity verification. Fingerprint recognition and face recognition are two biometric identification techniques commonly used in the prior art, which are usually used for unlocking the electronic devices such as mobile phones and computers, or identity authentication for financial transaction. The conventional identity authentication method, such as face recognition or fingerprint recognition, only uses one biometric feature and the convenience and the accuracy still need to be improved.

### SUMMARY OF THE INVENTION

To overcome the shortcomings, the present invention modifies the conventional identity authentication method to allow the user to pass the identity authentication more conveniently.

The present invention provides an identity authentication method comprising steps of:

obtaining an user's first biometric information and the user's second biometric information;

selecting a part of the first biometric information;

comparing the selected part of the first biometric information with a first enrollment information to generate a first value;

selecting a part of the second biometric information;

comparing the selected part of the second biometric information with a second enrollment information to generate a second value;

generating an output value based on the first and second values; and

verifying the user's identity according to the output value.

To achieve the aforementioned object, the present invention provides another identity authentication method comprising steps of:

obtaining an user's first biometric and the user's second biometric;

selecting a part of the first biometric;

comparing the selected part of the first biometric with a first enrollment datum to generate a first value;

comparing the second biometric with a second enrollment datum to generate a second value;

generating an output value based on the first and second values; and

verifying the user's identity according to the output value.

The invention has the advantages that partial biometric information of the user can be adopted in the biometric identification, which can improve the convenience of identity authentication. By adopting two biometric identifications, the accuracy of identity authentication can be maintained.

### BRIEF DESCRIPTION OF THE DRAWINGS

FIG. 1 is a block diagram of an electronic device to which an identity verification method in accordance with the present invention is applied;

FIG. 2 is a flow chart illustrating an embodiment of an identity verification method in accordance with the present invention using face recognition and fingerprint recognition;

FIGS. 3A and 3B are illustrative views to show a face image to be verified;

FIG. 4 is an illustrative view to show a face image enrolled by a user;

FIGS. 5A and 5B are illustrative views to illustrate selecting a portion form a fingerprint image;

FIGS. 6A and 6B are illustrative views to show a fingerprint image enrolled by a user;

FIG. 7 is a flow chart of one embodiment of an identity verification method in accordance with the present invention;

FIG. 8 is a flow chart of other embodiment of an identity verification method in accordance with the present invention;

FIG. 9 is an illustrative view to show a fingerprint comparison; and

FIG. 10 is an illustrative view to show face recognition.

### DETAILED DESCRIPTION OF THE EMBODIMENTS

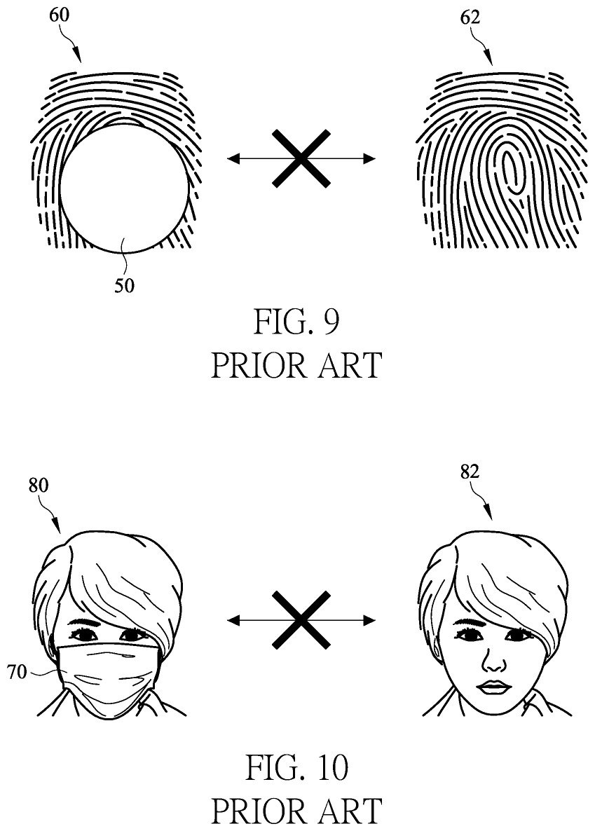

With reference to FIG. 9, a fingerprint image 60 of a user includes a defective area 50. The defective area 50 may be caused by the dirt or sweat on the surface of the fingerprint sensor or a part of the finger. Since the fingerprint 60 is incomplete and is very different from fingerprint 62 originally enrolled by the user, the fingerprint 60 must not pass the security authentication. As to the face recognition, FIG. 10 shows an illustrative view. If the user wears a mask 70 (or a pair of sunglasses) on the face, the captured image 80 is significantly different from the enrolled face image 82 and must not pass the identity authentication. However, no matter that the fingers have dirt or the user wears the mask or the sunglasses, those are common situation. Thus, the present invention provides an identity authentication method with both security and convenience.

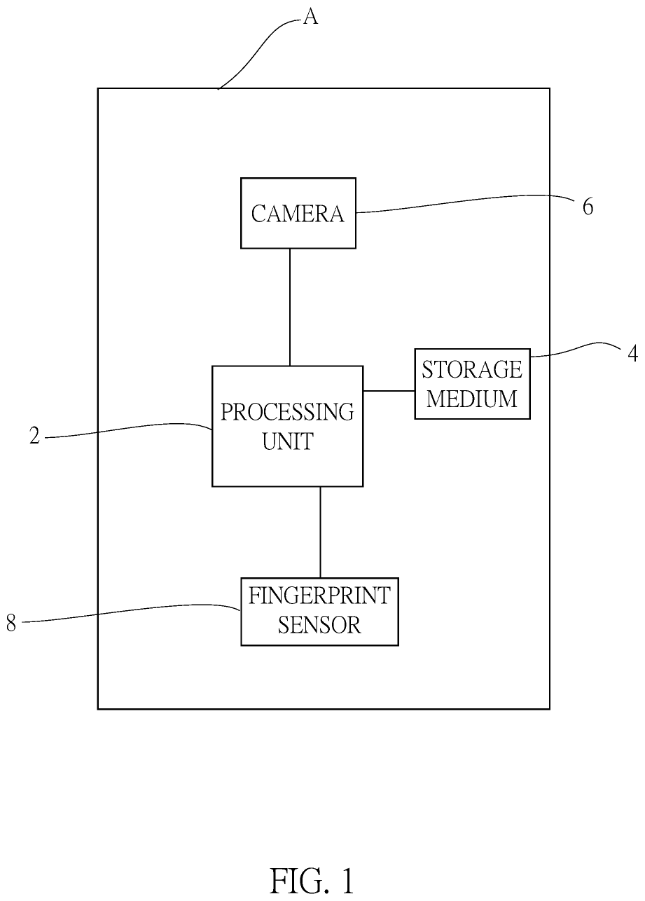

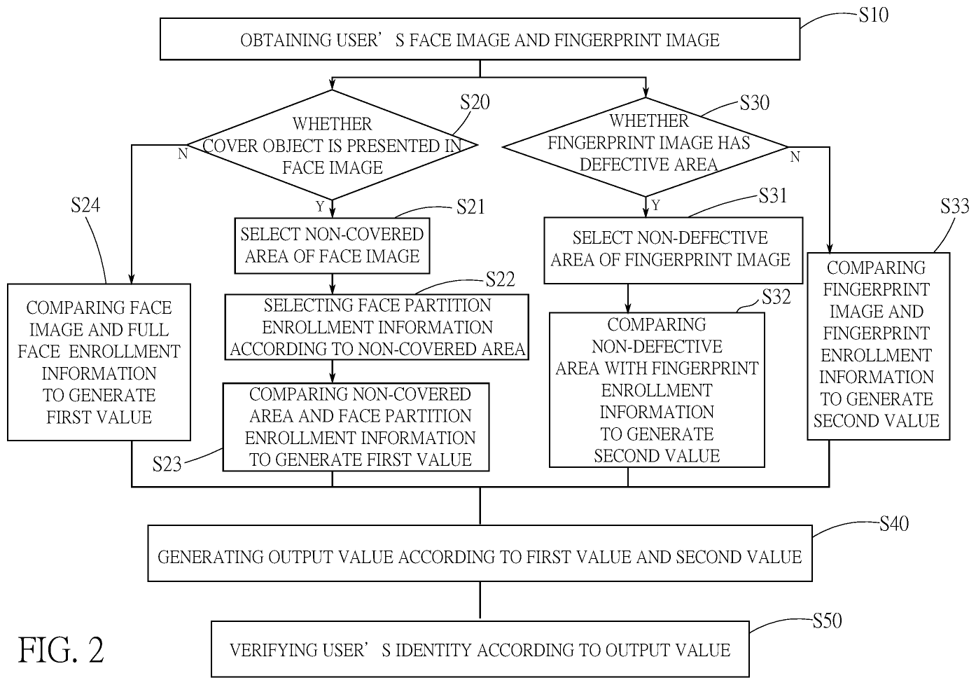

One feature of the present invention is to perform the identity verification by using two different biometric features. The two biometric features may be selected from the fingerprint, the face, the iris, the palm print and the voice print. For convenience of description, the embodiment of FIGS. 1 and 2 first describes the technical content of the present invention by using two biometric features namely face and a fingerprint, but are not limited thereto. An electronic device A shown in FIG. 1 may be a mobile phone, a computer or a personal digital assistant (PDA). The electronic device A comprises a processing unit 2, a storage medium 4, a camera 6 and a fingerprint sensor 8. The processing unit 2 is coupled to the storage medium 4, the camera 6 and the fingerprint sensor 8. The camera 6 is used for capturing a face image. The fingerprint sensor 8 may be a capacitive or an optical fingerprint sensor, and is used for sensing the fingerprints to generate a fingerprint image. The storage medium 4 stores programs and materials for identity authentication executed by the processing unit 2 using the face image and the fingerprint image.

The embodiment as shown in FIG. 2 illustrates an embodiment in accordance with the present invention which using face images and fingerprint images to perform identity authentication. The step S10 obtains the face image and the fingerprint image by shooting the user's face via the camera 6 and by sensing the user's finger via the fingerprint sensor 8.

After the captured face image and the fingerprint image are transmitted to the processing unit 2, the processing unit 2 may perform some preprocessing procedures to the face image and the fingerprint image, such as adjusting the size, orientation, scale of the images and so on, for the following face recognition and fingerprint recognition. In the step S20, the processing unit 2 determines whether a cover object, such as a mask or a pair of sunglasses, is presented in the face image. The cover object covers a part of a face in the face image. Artificial intelligence or image analysis technique may be applied to determine whether a cover object is presented in the face image. For example, the facial landmark detection may recognize the positions of the features (e.g., eyes, nose, mouth) in a face image. When applying the facial landmark detection to a face image and the mouth cannot be found, it means that the face image may include a mask covering the mouth. Similarly, when two eyes cannot be found in a face image, it means that the face image may include a pair of sunglasses covering the eyes. In the step S30, the processing unit 2 determines whether the fingerprint image has a defective area. Determining whether the fingerprint image has a defective area may be achieved in many ways. For example, the fingerprint image is divided into multiple regions. When the sum of the pixel values of one of the regions is larger or smaller than a threshold, or is significantly different to that of other regions, the region is determined as a defective area. Other techniques to determine whether a cover object is presented in the face image and to determine whether the fingerprint image has a defective area may also adapted to the present invention.

When the processing unit 2 determines that a cover object is presented in the face image in the step S20, the step S21 is proceeded to select a non-covered area from the face image. The selected non-covered area does not overlap the cover object. It means that the step S21 is to choose other parts of the face image that are not covered by the cover object. In the step S22, the processing unit 2 selects a set of face partition enrollment information according to the selected non-covered area. The content of the selected face partition enrollment information at least corresponds to the feature that included in the selected non-covered area, such as eyes or mouth.

The step S23 compares the selected non-covered area with the selected face partition enrollment information to generate a first value X1. In the step S23, the processing unit 2 first coverts an image of the selected non-covered area into a face information to be verified, and then calculates the similarity between the face information to be verified and the face partition enrollment information to generate the first value X1.

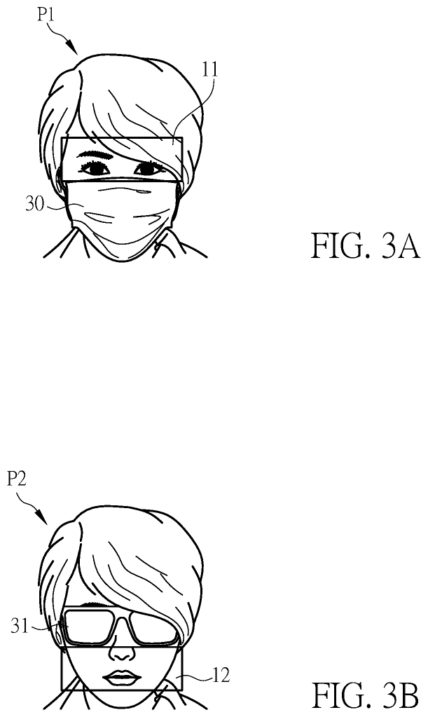

For example, the image P1 shown in FIG. 3A is a face image to be verified. When the processing unit 2 analyzes that a mask 30 exists in the face image P1, the processing unit 2 selects an upper area 11 of the face image P1 that is not covered by the mask 30 in the step S21, and selects a face partition enrollment information H1 according to the upper area 11 including the eyes in the step S22. One way to select the upper area 11 is to use the facial landmark detection to identify the two eyes from the face image P1 first, and then to extend a region of a predetermined size outwardly from a center of the two eyes to cover at least the two eyes. The upper area 11 includes the two eyes. The contents of the face partition enrollment information H1 at least including the two eyes. In the step S23, the processing unit 2 compares the image of the upper area 11 with the face partition enrollment datum H1 to generate the first value X1.

As the embodiment shown in FIG. 3B, the image P2 is a face image to be verified. When the processing unit 2 analyzes that a pair of sunglasses 31 exists in the face image P2, the processing unit 2 selects a lower area 12 of the face image P2 that is not covered by the pair of sunglasses 31 in the step S21, and selects a face partition enrollment information H2 according to the lower area 12 including the mouth in the step S22. One way to select the lower area 12 is to use the facial landmark detection to identify the mouth from the face image P2 first, and then to extend a region of a predetermined size outwardly from a center of the mouth to cover at least the mouth. The lower area 12 includes the mouth. The content of the face partition enrollment information H2 at least includes the mouth. In the step S23, the processing unit 2 compares the image of the lower area 12 with the face partition enrollment datum H2 to generate the first value X1.

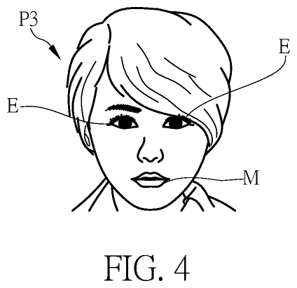

The aforementioned face partition enrollment information is generated by the processing unit 2 when the user performs the enrollment process of the face image. For example, the user enrolls the face image P3 as shown in FIG. 4 in the electronic device A. In one embodiment, the processing unit 2 selects multiple areas with different sizes that include the two eyes E. The images of the selected areas are processed by the artificial intelligence algorithm to generate enrollment information H1. Similarly, the processing unit 2 selects multiple areas with different sizes that include the mouth M. The images of the selected areas are processed by the artificial intelligence algorithm to generate enrollment information H2. In another embodiment, the processing unit 2 executes the artificial intelligence algorithm to extract the features of the face image P3 to generate full face enrollment information H. Since the full face enrollment information H is converted from the face image P3, the processing unit 2 may select a part of the full face enrollment information H including the two eyes E as enrollment information H1 and may select a part of the full face enrollment information H including the mouth M as enrollment information H2. For example, the full face enrollment information H includes a hundred parameters. The 30^{th} to 50^{th} parameters correspond to the two eyes E and the parts surrounding them and are used as the enrollment information H1. The 70^{th} to 90^{th} parameters correspond to the mouth and the parts surrounding it and are used as the enrollment information H2. As to the details to generate the face enrollment information according to a face image is well known to those skilled in the art of face recognition and therefore are omitted for purposes of brevity.

When the processing unit 2 determines that the face image has no cover object in the step S20, the step S24 is executed. The step S24 is to compare the face image obtained in the step S10 with full face enrollment information, such as the full face enrollment information H, to generate a first value X2. In the step S24, the processing unit 2 converts the face image into face information to be verified first, and then calculates the similarity between the face information to be verified and the full face enrollment information to generate the first value X2. In the FIG. 2, the first values as described in the steps S23 and S24 represent the recognition result of the face image, and does not means that the first values generated in the steps S23 and S24 are the same.

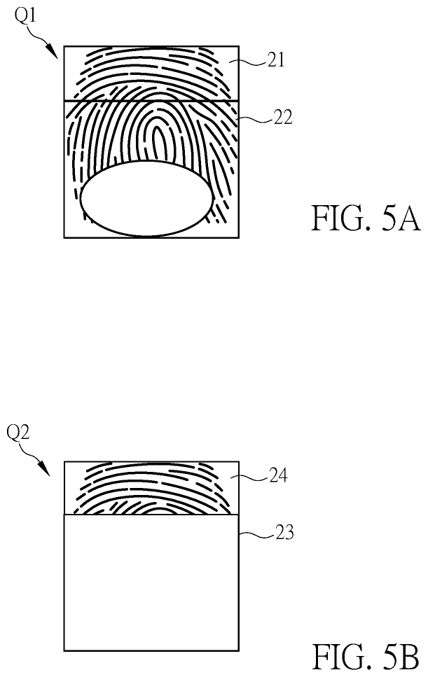

The step S30 is to determine whether the fingerprint image obtained in the step S10 has a defective area. The defective area 50 may be caused by the by dirt or sweat on the surface of the fingerprint sensor or a part of the finger. In the step S30, the processing unit 2 analyzes the fingerprint image to determine whether it has a defective area. When the processing unit 2 determines the fingerprint has a defective area, the step S31 is proceeded to select a non-defective area from the fingerprint image. The selected non-defective area does not overlap the defective area. It means that the step S31 is to select area other than the defective area of the fingerprint image. Then the processing unit 2 performs the step S32 according to the selected non-defective area. In the step S32, the processing unit 2 compares the image of the non-defective area with fingerprint enrollment information J to generate a second value Y1. For example, as shown in FIG. 5A, the processing unit 2 analyzes that the defective area 22 exists in the lower half of the fingerprint image Q1. Then the processing unit 2 selects the first area 21 other than the defective area 22 to compare with the fingerprint enrollment information J to generate the second value Y1. Alternatively, as shown in FIG. 5B, the processing unit 2 may process the fingerprint image Q1 to replace the defective area 22 shown in FIG. 5A with a blank area 23 so that a fingerprint image Q2 after the processing is composed of the upper area 24 and the blank area 23. Then the fingerprint image Q2 is compared with the fingerprint enrollment information J. In this example, replacing the defective area 22 with the blank area 23 is equivalent to selecting the upper area 24 other than the defective area 22. During the fingerprint comparison, the upper area 24 of the fingerprint image is used to compare with the fingerprint enrollment datum J since the blank area 23 does not have fingerprint.

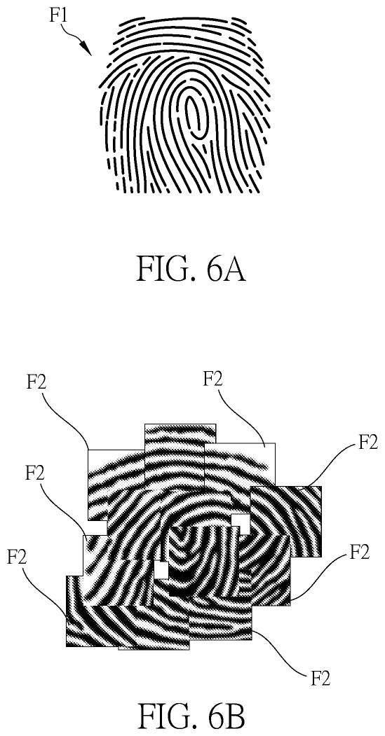

The aforementioned fingerprint enrollment information J is generated by the processing unit 2 when the user performs the enrollment process of the fingerprint. In one embodiment, the size of the fingerprint sensor 8 is bigger enough to sense a full fingerprint of a finger, such as the fingerprint F1 shown in FIG. 6A. During the fingerprint enrollment, the processing unit senses the user's fingerprint, such as the fingerprint F1, to generate the fingerprint enrollment information J and to store the fingerprint enrollment information J in the storage medium 4. In another embodiment, the size of the fingerprint sensor 8 is smaller, such as only 1/10 of the finger area. During the fingerprint enrollment, the fingerprint sensor 8 senses the user's finger for multiple times to obtain multiple fingerprint images F2 as shown in FIG. 6B. Each fingerprint image F2 is corresponding to a partial fingerprint of the user. The processing unit 2 generates fingerprint enrollment information J1 according to the multiple fingerprint images F2 and stores the fingerprint enrollment information J1 in the storage medium 4. The fingerprint enrollment information J1 includes multiple pieces of enrollment information respectively corresponding to the multiple fingerprint images F2. The fingerprint enrollment is well known to those skilled in the art of fingerprint recognition and therefore is omitted for purposes of brevity.

When the processing unit 2 determines that the fingerprint image has no defective area in the step S30, the step S33 is performed. In the step S33, the processing unit 2 compares the fingerprint image obtained in the step S10 with fingerprint enrollment information, such as the aforementioned fingerprint enrollment information J or J1, to generate a second value Y2. In the FIG. 2, the second values as described in the steps S32 and S33 represent the recognition result of the fingerprint image, and does not means that the second values generated in the steps S32 and S33 are the same.

In the steps S32 and S33, the conventional fingerprint comparison method may be applied to compare partial or full fingerprint image with the fingerprint enrollment information. The minutiae points are extracted from the fingerprint image to be verified and are compared with the fingerprint enrollment information. Details of the fingerprint comparison are well known to those skilled in the art of fingerprint recognition and therefore are omitted for purposes of brevity.

In one embodiment, the aforementioned first value and second value are scores to represent the similarity. The higher the score is, the higher the similarity is. The step S40 is to generate an output value according to the first value and the second value. In the step S40, the processing unit 2 calculates an output value S according to the first value generated in the step S23 or S24 and the second value generated in the step S32 or S33. The step S50 is to verify the user's identity according to the output value S generated in the step S40, so as to determine whether the face image and the fingerprint image obtained in the step S10 match the user enrolled in the electronic device A. In one embodiment, the processing unit 2 compares the output value S generated in the S40 with a threshold. According to the comparison result, a verified value 1 is generated to represent that the identity authentication is successful, or a verified value 0 is generated to represent that the identity authentication is failed.

For example, the step S40 generates an output value S1=A1×X1+B1×Y1 based on the first value X1 generated in the step S23 and the second value Y1 generated in the step S32. The step S40 generates an output value S2=A1×X1+B2×Y2 based on the first value X1 generated in the step S23 and the second value Y2 generated in the step S33. The step S40 generates an output value S3=A2×X2+B1×Y1 based on the first value X2 generated in the step S24 and the second value Y1 generated in the step S32. The step S40 generates an output value S4=A2×X2+B2×Y2 based on the first value X2 generated in the step S24 and the second value Y2 generated in the step S33. The symbols S1 to S4 represent the output values and the symbols A1, A2, B1 and B2 represent the weight values. Since the step S24 executes the face recognition with the full face image, the accuracy of the identity authentication executed in the step S24 is better than the accuracy of the identity authentication executed in the step S23, which executes the face recognition with the partial face image. Thus, the weight value A2 is larger than the weight value A1. For different non-covered areas of the face image, different weight values A1 may be used. For different non-defective areas of the fingerprint image, different weights B1 may be used. Since the step S33 executes the fingerprint recognition with the full fingerprint image, the accuracy of the identity authentication executed in the step S33 is better than the accuracy of the identity authentication executed in the step S32, which executes the fingerprint recognition with the partial fingerprint image. Thus, the weight value B2 is larger than the weight value B1. In one embodiment of the step S50, the output value generated in the step S40 is compared with a threshold to generate a verified value which represents the authentication result of the user's identity. When the output value is larger than the threshold, a verified value 1 is generated to represent that the identity authentication is successful. When the output value is smaller than the threshold, a verified value 0 is generated to represent that the identity authentication is failed. For different situations, the step S50 may use different thresholds. For example, a threshold TH1 is used to compare with the output value S1. A threshold TH2 is used to compare with the output value S2. A threshold TH3 is used to compare with the output value S3. A threshold TH4 is used to compare with the output value S4. The thresholds TH1 to TH4 are determined based on the weight values A1, A2, B1 and B2. In one embodiment, the weight A2 is larger than the weight A1, the threshold TH3 is larger than the threshold TH1, the weight B2 is larger than the weight B1, and the threshold TH4 is larger than the threshold TH2. In other embodiments, depending on the actual security and convenience requirements, the threshold TH3 may be less than or equal to the threshold TH1, and the threshold TH4 may be less than or equal to the threshold TH2.

It can be understood from the above description that the embodiment of FIG. 2 combines the face recognition and the fingerprint recognition, wherein the face recognition is performed with a full face image or a partial face image, and the fingerprint recognition is performed with a full fingerprint image or a partial fingerprint image. Thus, the embodiment shown in FIG. 2 includes four recognition combinations, which includes:

Combination I: Full face image recognition and full fingerprint image recognition.

Combination II: Full face image recognition and partial fingerprint image recognition.

Combination III: Partial face image recognition and full fingerprint image recognition.

Combination IV: Partial face image recognition and partial fingerprint image recognition.

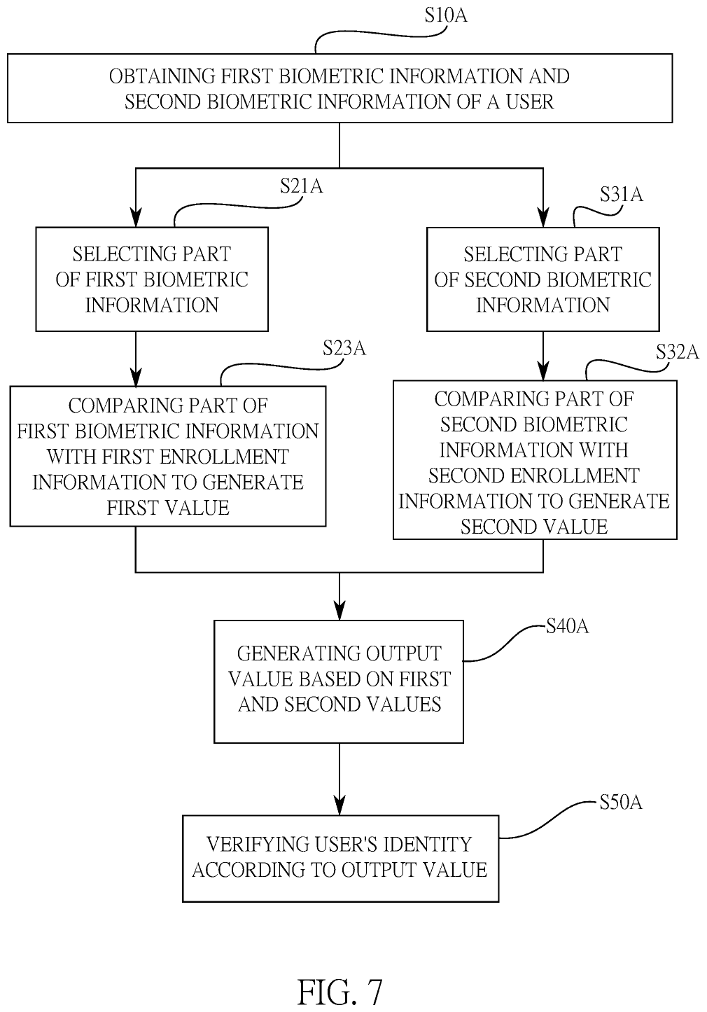

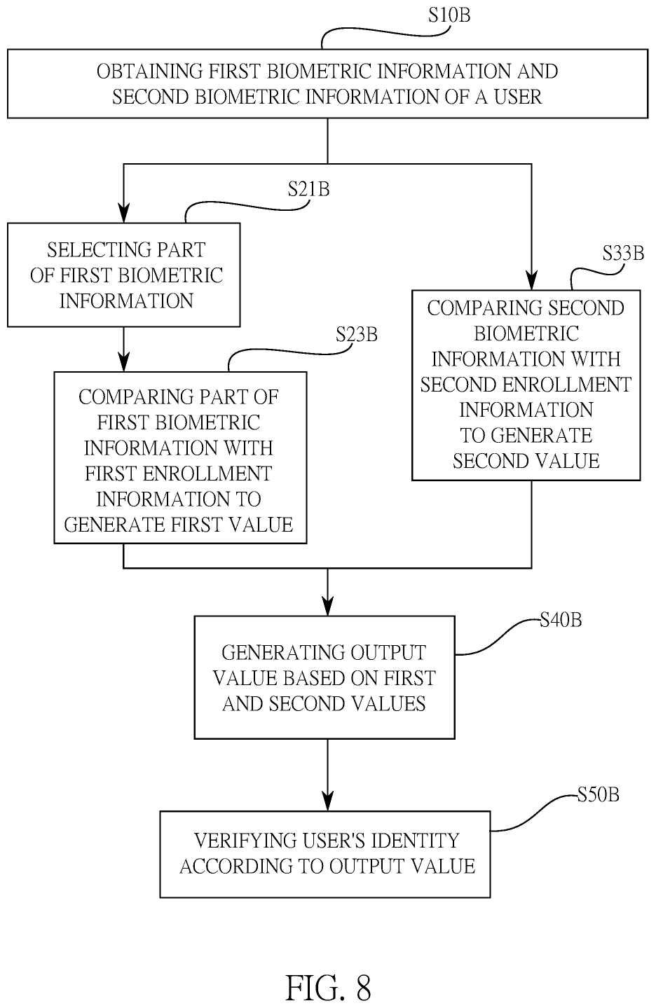

The aforementioned embodiments are described with two biometric features, face and fingerprint, and the present invention is also applicable to other different biometric features. Therefore, it can be understood from FIG. 2 and the above combinations II, III and IV that the embodiments of the present invention at least include an authentication performed with a part of the first biometric feature and a part of the second biometric feature, and an authentication performed with a part of the first biometric and full of the second biometric. The two embodiments are shown respectively in FIGS. 7 and 8.

The flowchart in FIG. 7 comprises following steps:

Obtaining first biometric information and second biometric information of a user (S10A);

Selecting a part of the first biometric information (S21A);

Comparing the selected part of the first biometric information with first enrollment information to generate a first value (S23A);

Selecting a part of the second biometric information (S31A);

Comparing the selected part of the second biometric information with second enrollment information to generate a second value (S32A);

Generating an output value based on the first and second values (540A); and

Verifying the user's identity according to the output value (550A).

With reference to FIG. 8, another embodiment of the method in accordance with the present invention comprises following steps:

Obtaining first biometric information and second biometric information of a user (S10B);

Selecting a part of the first biometric information (S21B);

Comparing the selected part of the first biometric information with first enrollment information to generate a first value (S23B);

Comparing the second biometric information with second enrollment information to generate a second value (S33B);

Generating an output value based on the first and second values (S40B); and

Verifying the user's identity according to the output value (S50B).

When the first biometric information as indicated in the embodiments shown in FIGS. 7 and 8 is face image, the details of the steps S21A, S21B, S23A and S23B may respectively refer to the related descriptions of the steps S21 and S23 of the embodiment shown in FIG. 2. When the second biometric information as indicated in the embodiments shown in FIGS. 7 and 8 is fingerprint image, the details of the steps S31A, S32A and S33B may respectively refer to the related descriptions of the steps S31, S32 and S33 of the embodiment shown in FIG. 2. When the first biometric information as indicated in the embodiments shown in FIGS. 7 and 8 is fingerprint image, the details of the steps S21A, S21B, S23A and S23B may respectively refer to the related descriptions of the steps S31 and S32 of the embodiment shown in FIG. 2. When the second biometric information as indicated in the embodiments shown in FIGS. 7 and 8 is face image, the details of the steps S31A, S32A and S33B may respectively refer to the related descriptions of the steps S21, S23 and S24 of the embodiment shown in FIG. 2.

The details of the step S40A in FIG. 7 and the step S40B in FIG. 8 is to sum a product of multiplying the first value by a first weight value and a product of multiplying the second value by a second weight value to generate the output value. When the first biometric information is face image and the second biometric information is fingerprint image, the more details may refer to the related description of the step S40.

As can be appreciated from the above description, the present invention performs identity authentication with two different types of biometric information. Partial biometric information can also be used for passing the authentication. Taking the face recognition and the fingerprint recognition as an example, even if a person wears a cover object such as a mask or a pair of sunglasses, or the finger is sweaty or dirty, the identity authentication can still be performed by the present invention. The present invention is clearly more convenient and/or more accurate than the conventional methods which authenticating a user with a single biometric.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

What is claimed is:

1. An identity authentication method comprising steps of:
obtaining first biometric information and second biometric information of a user;
selecting a part of the first biometric information;
comparing the selected part of the first biometric information with first enrollment information to generate a first value;
selecting a part of the second biometric information;
comparing the selected part of the second biometric information with second enrollment information to generate a second value;
generating an output value based on the first value and the second value; and
verifying the user's identity according to the output value.

2. The identity authentication method as claimed in claim 1, wherein the first biometric information and the second biometric information are different biometric information and are selected from a fingerprint, a face, an iris, a palm print and a voice print.

3. The identity authentication method as claimed in claim 1, wherein the step of generating an output value based on the first and second values comprises a step of:
generating the output value by summing a product of multiplying the first value by a first weight value and a product of multiplying the second value by a second weight value.

4. The identity authentication method as claimed in claim 1, wherein the first biometric information is a face image and the identity authentication method comprises steps of:
determining whether a cover object is presented in the face image, wherein the cover object covers a part of a face in the face image; and
proceeding the step of selecting a part of the first biometric information to select a non-covered area from the face image in response to determining that the cover object is presented in the face image.

5. The identity authentication method as claimed in claim 4 further comprising:
determining corresponding enrollment information based on the non-covered area.

6. The identity authentication method as claimed in claim 1, wherein the second biometric information is a fingerprint image and the identity authentication method comprises steps of:
determining whether the fingerprint image has a defective area; and
proceeding the step of selecting a part of the second biometric information to select a non-defective area from the fingerprint image in response to determining that the fingerprint image has a defective area.

7. The identity authentication method as claimed in claim 4, wherein the second biometric information is a fingerprint image and the identity authentication method comprises steps of:
determining whether the fingerprint image has a defective area; and
proceeding the step of selecting a part of the second biometric information to select a non-defective area from the fingerprint image in response to determining that the fingerprint image has a defective area.

8. The identity authentication method as claimed in claim 4, wherein the selected part of the first biometric information includes two eyes or a mouth in the face image.

9. An identity authentication method comprising steps of:
obtaining first biometric information and second biometric information of a user;
selecting a part of the first biometric information;
comparing the selected part of the first biometric information with first enrollment information to generate a first value;
comparing the second biometric information with second enrollment information to generate a second value;
generating an output value based on the first and second values; and
verifying the user's identity according to the output value.

10. The identity authentication method as claimed in claim 9, wherein the first biometric information and the second biometric information are different biometric information and are selected from a fingerprint, a face, an iris, a palm print and a voice print.

11. The identity authentication method as claimed in claim 9, wherein the step of generating an output value based on the first and second values comprises a step of:
generating the output value by summing a product of multiplying the first value by a first weight value and a product of multiplying the second value by a second weight value.

12. The identity authentication method as claimed in claim 9, wherein the first biometric information is a face image and the identity authentication method comprises steps of:
determining whether a cover object is presented in the face image, wherein the cover object covers a part of a face in the face image; and
proceeding the step of selecting a part of the first biometric information to select a non-covered area from the face image in response to determining that the cover object is presented in the face image.

13. The identity authentication method as claimed in claim 12 further comprising determining corresponding enrollment information based on the non-covered area.

14. The identity authentication method as claimed in claim 9, wherein the first biometric information is a fingerprint image and the identity authentication method comprises steps of:
determining whether the fingerprint image has a defective area; and
proceeding the step of selecting a part of the first biometric information to select a non-defective area from the fingerprint image in response to determining that the fingerprint image has a defective area.

15. The identity authentication method as claimed in claim 12, wherein the selected part of the first biometric information includes two eyes or a mouth in the face image.
